(19) United States
(12) Patent Application Publication
(10) Pub. No.: US 2013/0074850 A1
(43) Pub. Date: Mar. 28, 2013

(54) MOUTHPIECE INSECT SHIELD

(71) Applicant: EDWARD LENART, Farmington Hills, MI (US)

(72) Inventor: EDWARD LENART, Farmington Hills, MI (US)

(21) Appl. No.: 13/247,772

(22) Filed: Sep. 28, 2011

(51) Int. Cl. A61C 5/14

(52) U.S. Cl. 128/861; 128/859

(57) ABSTRACT

A mouthpiece is disclosed. The mouthpiece may include a screen to prevent airborne foreign objects from entering a user's mouth. The mouthpiece may include a bite guard and a shield disposed to cover around the lips.

### BACKGROUND OF THE INVENTION

The present invention generally relates to protective equipment, and more particularly, to a Mouthpiece Insect Shield.

During physical activities such as: running, biking, walking and playing soccer, a person's mouth is exposed to all kind of flying bugs and other foreign objects. These bugs and airborne objects unexpectedly enter a person's mouth causing a potential choking hazard, swallowing and/or fatal distraction if riding a bike.

Also, the teeth may be subject to cracking and the lips vulnerable to cuts, if a person falls and/or makes unexpected contact with hard objects.

As can be seen, there is a need for a mouthpiece shield that protects the inside and outside of a person's mouth.

### SUMMARY OF THE INVENTION

In one aspect of the present invention, a mouthpiece comprises a shield portion adapted to surround and cover the lips of a user; an attachment portion configured to hold the shield portion over the lips of the user; and a mesh screen attached to the shield portion disposed to filter objects from entering a mouth interior.

In another aspect of the present invention, a mouthpiece comprises a bite guard; a body disposed to project around a perimeter of the bite guard, wherein the body defines an opening inside the perimeter; and a screen attached to the body within the opening and positioned anterior of the bite guard.

These and other features, aspects and advantages of the present invention will become better understood with reference to the following drawings, description and claims.

### BRIEF DESCRIPTION OF THE DRAWINGS

FIG. 1 is a perspective view of a mouthpiece shield according to an exemplary embodiment of the present invention in use;

FIG. 2 is a perspective view of the mouthpiece of FIG. 1;

FIG. 3 is an exploded perspective view of the mouthpiece of FIG. 1;

FIG. 4 is a perspective section view of the mouthpiece taken along line 4-4 of FIG. 2.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims. Various inventive features are described below that can each be used independently of one another or in combination with other features.

Broadly, embodiments of the present invention generally provide a mouthpiece that protects both the exterior and interior of the user's mouth. In one aspect, the exemplary embodiments of the mouthpiece prevent bugs and other airborne foreign objects from entering the user's mouth during activity that may distract or cause a choking hazard. Exemplary embodiments disclosed may provide for a person's mouth to be always open with teeth and lips separated, resting in channels, which may act like a shock absorbing device. The lips may be protected by a soft shield extension. In another aspect, the mouthguard may also provide a shield over the user's mouth that protects a users lips and teeth from injury.

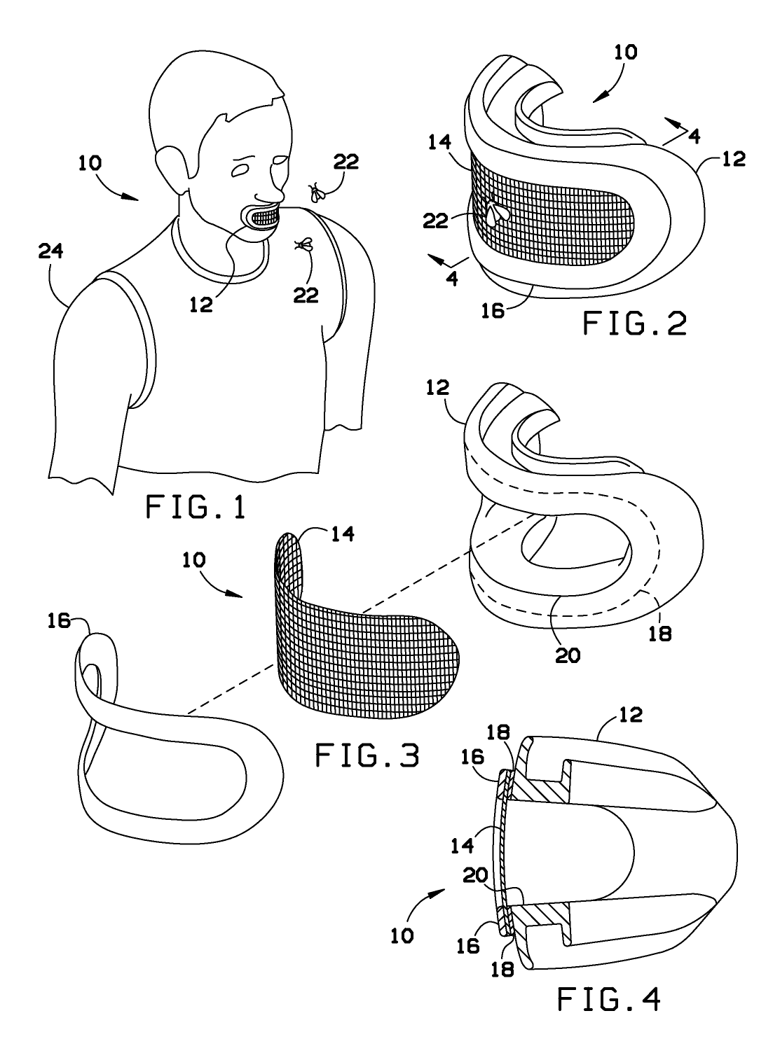

Referring now to FIGS. 1-4, a mouthpiece 10 is shown according to an exemplary embodiment of the present invention. The mouthpiece 10 includes a body 12 adapted to fit around a user's 24 mouth. The body 12 may be concave and shaped to wrap around the user's 24 mouth. The body 12 may include a shield 18 and a bite guard 25. The body 12 may be made from, for example, non-toxic rubber or soft plastic.

The bite guard 25 may be disposed on a posterior side of the body 12. The bite guard 25 may include upper and lower trays 26;28 adapted to accommodate the user's 24 upper and lower sets of teeth. In a default position, the upper and lower trays 26;28 may be spaced apart defining an opening 20 there between that frames the opening defined by the user's 24 lips when his mouth is agape. An interior surface 21 disposed behind the opening 20 may be sloped and configured to follow the contours of a user's 24 jaw (not shown).

The shield 18 may be configured in a generally oval shaped flange framing the perimeter of the opening 20. The shield 18 may project radially from the opening 20 lying over and fully covering the lips of the user 24. The shield 18 may include a thickness approximately 3 mm deep. The shield 18 may be concave and include left and right ends 15;17 configured to project rearward toward the user's 24 jaw joints. The left and right ends 15;17 may include a rear suction surface 30 that may be configured to pressure seal onto the user's 24 face.

The mouthpiece 10 may further include a mesh screen 14 to keep foreign objects from entering the user's 24 mouth. The screen 14 may be attached to the body 12 to cover the opening 20. The mesh screen 14 may also be positioned between the user's lips when the lips are agape. In one exemplary embodiment, the screen 14 may be removably fastened to the body 12 and held in place by a frame 16 that may be made from non-toxic rubber or soft plastic. However, in another aspect, it will be understood that the screen 14 may also be integrated directly into the body 12. In another exemplary embodiment, the screen 14 may also be integrated into the frame 16 which as a unit, may be separable from and attached to the body 12 at the user's 24 convenience.

In an exemplary use of the mouthpiece 10, the user 24 may insert the mouthpiece 10 into his mouth and bite onto the bite guard 25. In one aspect, the bite guard 25 may serve as an attachment portion of the mouthpiece 10 to the user 24. In another aspect, the rear suction surface 30 may serve as the attachment portion.

As the user 24 engages in physical activity, for example athletic endeavors, the bite guard 25 may support the user's 24 mouth agape while the screen 14 helps prevent airborne foreign objects 22, (such as flies) from entering the user 24 mouth. The user 24 may thus be free to breathe through his or her mouth instead of the nose. More oxygen may be inhaled into the users body and the user 24 can be more effective and generate more energy. Moreover, it may be appreciated that the shield 18 extends to protect the user's 24 lips from harm. For example, in athletic endeavors, the user's 24 lips being disposed behind the shield 18 may escape rupturing. In another exemplary use, when a user 24 is riding in an open vehicle, the lips may be shielded from drying wind, preventing cracking. In another aspect, during an inadvertent strike to the mouth, the thickness of the shield 18 may add another layer of shock absorbsion for teeth that are already protect by the bite guard 25. Moreover, the extended periphery of the left and right ends 15;17 may provide increased jaw stability, for example, during impact on the mouthpiece 10.

It should be understood, of course, that the foregoing relates to exemplary embodiments of the invention and that modifications may be made without departing from the spirit and scope of the invention as set forth in the following claims. Although embodiments of the invention are illustrated as an insect shield, it will be understood that the screen of present invention may employ a dust shield or filter by replacing the mesh screen with any material including but not limited to filter paper as known by those in the art.

What is claimed is:

1. A mouthpiece, comprising:
a shield portion adapted to surround and cover the lips of a user;
an attachment portion configured to hold the shield portion over the lips of the user; and
a mesh screen attached to the shield portion, positioned between a users agape lips disposed to filter objects from entering a mouth interior.

2. The mouthpiece of claim 1, wherein the attachment portion comprises a bite guard disposed on a posterior side of the shield portion.

3. The mouthpiece of claim 1, wherein the shield portion includes a concave body disposed to lie over the user's lips with left and right ends of the body projecting rearward toward the user's jaw joints.

4. The mouthpiece of claim 3, wherein the concave body defines a central opening extending between the body left and right ends.

5. A mouthpiece, comprising:
a bite guard;
a body disposed to project around a perimeter of the bite guard, wherein the body defines an opening inside the perimeter; and
a screen attached to the body within the opening and positioned anterior of the bite guard.

6. The mouthpiece of claim 5, further comprising a frame disposed over a perimeter of the screen.

7. The mouthpiece of claim 5, wherein the body includes a shield portion disposed to lie over a user's lips.

8. The mouthpiece of claim 5, wherein the bite guard includes upper and lower trays configured spaced apart in a default position.

9. The mouthpiece of claim 5, wherein the screen is integrated into the body.

10. The mouthpiece of claim 5, wherein the screen is removably attached to the body.
